(19) United States
(12) Patent Application Publication
(10) Pub. No.: US 2005/0055150 A1
(43) Pub. Date: Mar. 10, 2005

(54) Speed regulator with a plurality of operating modes

(76) Inventors: Werner Uhler, Bruchsal (DE); Michael Weilkes, Sachsenheim (DE); Michael Scherl, Bietigheim (DE); Harald Michi, Oelbronn-Duerrn (DE); Hermann Winner, Bietigheim (DE)

Correspondence Address: KENYON & KENYON, ONE BROADWAY, NEW YORK, NY, 10004, US

(21) Appl. No.: 10/496,434

(22) PCT Filed: May 19, 2003
(86) PCT No.: PCT/DE03/01605

(30) Foreign Application Priority Data
Nov. 22, 2002 (DE) 102 54 582.0

(51) Int. Cl. G06F 7/00

(52) U.S. Cl. 701/93

(57) ABSTRACT

A speed control for motor vehicles having an input device for the input of a desired speed by the driver, and having a plurality of operating modes which are able to be activated in different speed ranges and differ in their functional scope. A decision unit is provided which automatically undertakes the switchover of the operating mode in the light of the actual speed of the vehicle.

### FIELD OF THE INVENTION

The present invention relates to a speed control for motor vehicles.

### BACKGROUND INFORMATION

Germany Patent Application No. DE 199 58 120 describes, an example of a speed control which, on the one hand, is operable in a so-called ACC mode (adaptive cruise control) and, on the other hand, is operable in a so-called Stop and Go mode.

In the ACC mode, the speed of the vehicle is controlled to a desired speed selected by the driver, provided the roadway ahead of his own vehicle is free or preceding vehicles are moving faster or are far enough ahead. A distance sensor, such as a radar sensor, permits detecting preceding vehicles and other obstacles on the driver's own roadway, and, if necessary, adapting the speed in such a way that the vehicle traveling directly ahead may be followed at an appropriate safety distance. The ACC mode is generally provided for travel on express highways or well-improved highways at well moving traffic, that is, for traffic situations which are characterized by relatively low dynamics and relatively large distances between vehicles. Under these conditions, for recording the surrounding traffic field, it is sufficient to have a long-range direction-finding radar having comparatively low depth resolution. The relative speed of the located object is directly measurable with the aid of the Doppler effect. In order to avoid frequent faulty reactions of the system, in general only moving radar objects are considered as relevant target objects, since in general it is not to be expected that standing obstacles are on the roadway. However, in traffic situations having higher dynamics, such as in slow-moving traffic or Stop and Go traffic, or even in city traffic, standing targets should be included in the evaluation. In addition, because of the generally shorter vehicle separation distances, an even more detailed recording and evaluation of the traffic is desirable. The ACC mode is not suitable for this traffic situation, and may therefore be activated only if the speed of one's own vehicle is greater than a certain limiting speed, for instance, greater than 30 km/h.

On the other hand, the Stop and Go mode is provided for the lower speed range, and offers functions which are not available in the ACC mode, particularly the function of automatic braking of one's own vehicle to a standstill, such as when driving up to the end of a traffic jam. Under certain conditions, automatic driveaway is then possible again, when the preceding vehicle is set in motion again. These conditions are satisfied, for example, if one's own vehicle has stood still only relatively briefly, and if the target object followed up to now, i.e., the preceding vehicle, has steadily remained within the locating range of the distance sensor. Under different conditions, on the other hand, it may be expedient to deactivate the system entirely, or, upon driveaway of the preceding vehicle, just to emit a driveaway request to the driver, and to leave the final decision up to the driver. For the broadened functionality in Stop and Go mode, not only is the recording of standing targets required, but generally also an additional close-range sensor system is desirable, such as one in the form of a video system having electronic image evaluation, a close-range radar or a light-optical distance sensor for the close range, including the left and right roadway edges, so that even suddenly appearing obstacles may be recognized early. This more complex recording and evaluation of the traffic surroundings, which is requisite for the Stop and Go mode, or at least desirable, could, however, lead to faulty reactions at higher speeds. For this reason, Stop and Go mode is activable only at speeds up to an upper borderline speed, for instance, up to 40 km/h.

In the overlap zone between the speed ranges for ACC and Stop and Go, thus between 30 and 40 km/h in the assumed example, both modes are activable, and the selection of mode remains left to the driver. In the conventional systems, special mode selection keys are provided for selecting the operating mode, using which the driver is able to activate either the ACC mode or the Stop and Go mode. The active participation of the driver in selecting the operating mode is regarded as being meaningful, because in this manner it is brought to the driver's attention in which mode the system just happens to be, and which functions of the cruise control are available. In that way, it is particularly avoided that the driver erroneously assumes, when the vehicle ahead is standing still, that the cruise control is in a Stop and Go mode, and relies on the cruise control automatically to brake the vehicle to a standstill. However, some drivers feel that the necessity of selecting the operating mode themselves is an impairment of operating convenience, and the command keys needed for this purpose make the operating system more muddled and requiring explanation.

### SUMMARY

An example speed control according to the present invention, upon proper consideration of the safety aspects, offers the advantage of greater operating convenience and greater clarity and plausibility of the operating system.

The speed control according to the present invention is in a position of automatically undertaking the change in operating mode, provided that the conditions for this are given. Therefore, the driver is considerably relieved, and special command keys for the selection of the operating mode may be omitted. The most important criterion for the decision concerning a mode change is the actual speed V of the vehicle. For reasons of clarity, one should here regard as the actual speed the speed indicated to the driver on the tachometer.

In order to increase transparency, it may be preferred if the driver has it pointed out to him by a suitable signal, such as an optical or an acoustical signal, that a mode change has taken place, and in which mode the speed control is now.

In one preferred example embodiment, the speed control has only two main operating modes, namely the ACC mode and a mode which is here denoted as “Stop & Roll” (S&R). The concept “Stop & Roll” refers to a mode which falls between the ACC mode and the Stop & Go mode discussed at the beginning, with respect to the sensor system it requires and the complexity when it comes to evaluate the traffic environment. In the Stop & Roll mode, as in the Stop & Go mode, automatic braking of the vehicle to a standstill is possible, but, because of the restricted sensor system, this mode is not intended highly dynamic traffic situations, of the kind one might encounter in city traffic.

In order to avoid frequent change of modes, it is expedient if the switching takes place as a function of the actual speed in conjunction with a certain hysteresis. Thereby it is particularly achieved that the speed control remains in the current mode if the speed lies within the overlap region in which both operating modes are permitted.

In both main operational modes an override by operating the gas pedal is possible, just as with usual speed controls of this sort. The acceleration request input by the driver on the gas pedal then has precedence over the lesser setpoint acceleration calculated by the speed control. Even in these override situations a change is possible between the two main modes.

When the speed control has been deactivated, it can be reactivated by the input of a desired speed. Preferably, there then follows the decision whether the ACC mode or the Stop & Roll mode shall be activated, as a function of whether the actual speed lies above or below the limiting speed for ACC.

### BRIEF DESCRIPTION OF THE DRAWINGS

An exemplary embodiment of the present invention is explained in detail in the following description and is shown in the following figures:

FIG. 1 shows a block diagram of a speed control.

FIG. 2 shows a diagram of speed ranges at which the various operating modes of the speed control are able to be activated.

FIG. 3 shows a diagram for explaining the transitions between the various main operating modes and conditions of the speed control.

### DETAILED DESCRIPTION OF AN EXAMPLE EMBODIMENT

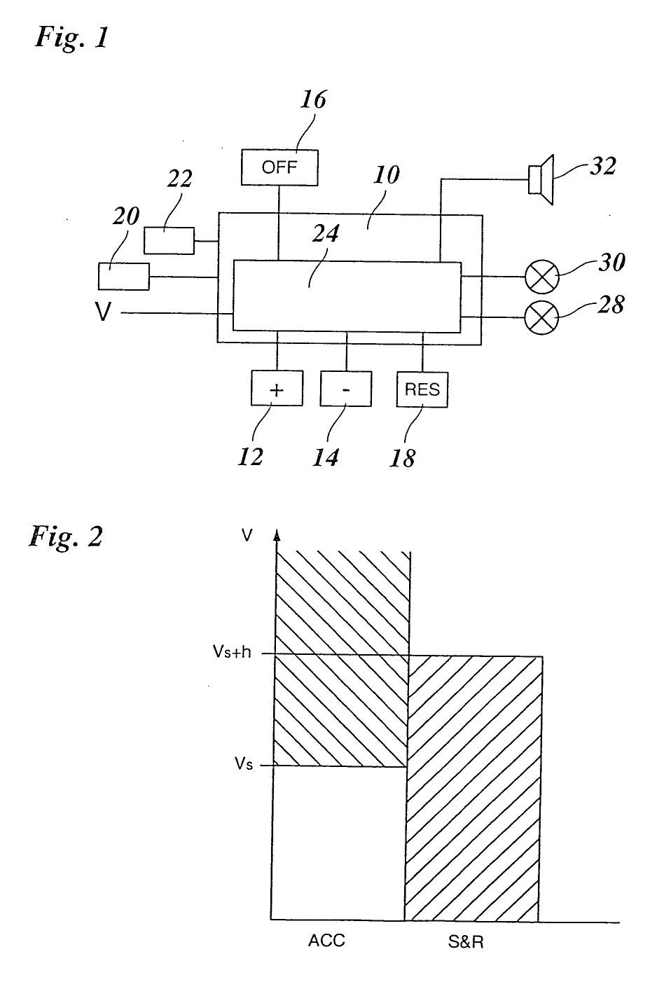

In FIG. 1, a speed control 10 is shown as a block diagram by which, in a manner that is conventional but not described in greater detail here, the speed of a motor vehicle is controlled to a desired speed selected by the driver. To operate speed control 10, a multifunctional lever is provided on the steering wheel, which fulfills the functions of several function keys: a “+” key 12 to activate the control and for raising the desired speed Vₛₑₜ, for example, in steps of 10 km/h, a “−” key 14 for activating the control and for reducing desired speed Vₛₑₜ, an OFF key 16 for deactivating the control and a resume key 18 for renewed activation of the control, while assuming the desired speed prevailing before the last deactivation. In response to the first activation of the control with the aid of the “+” key or “−” key, the actual speed V of the vehicle rounded up or down to the next full 10 is assumed as the desired speed Vₛₑₜ of the vehicle, just as it is indicated on the tachometer. When resume key 18 is pressed, without a desired speed having been stored, for the determination of the desired speed, one rounds up or down to the nearest whole ten that deviates the least from the actual speed.

Speed control 10 takes up signals from a long range distance sensor 20, such as a long range radar and from a short range sensor system 22, which is formed, for example, by a short range radar, a light-optical distance sensor system, a video system and the like. When the sensor system detects a preceding vehicle traveling in one's own lane, if necessary, the speed of the vehicle is reduced to below the desired speed set, so that the preceding vehicle may be followed at an appropriate safety distance, for instance, at a selectable time gap of 1 to 2 seconds. In one operating mode, known as ACC (adaptive cruise control), the spacing regulation takes place exclusively with the aid of signals of long range distance sensor 20, which has a locating range such as 10 to 200 m. This operating mode is provided for travel on express highways and well constructed highways at flowing traffic, that is, for traffic situations in which, in general, people travel at relatively high speeds. In addition, speed control 10 has a control mode which is designated as Stop & Roll (S&R) and is provided for traffic situations having high traffic density and correspondingly low speed, such as for slow-moving traffic or traffic jam operation on express highways or regular highways. In this mode, signals of the short range sensor system 22 are also evaluated, so that shorter vehicle spacing may be detected more accurately. Whereas in the ACC mode only movable objects are considered as relevant target objects, in the Stop & Roll mode other standing targets also have to be evaluated which are detected by long range distance sensor 20 or by close range sensor system 22. In addition, close range sensor system 22 also has a greater locating angular range, so that objects can also be detected which in the close range are located on neighboring lanes or at the edge of the roadway. Hereby the system is put into a position of reacting in time to suddenly appearing obstacles, such as vehicles suddenly swinging in from the side lane.

The Stop & Roll mode has at least one controlling function which is not available in the ACC mode, in particular, a stop function by which the vehicle may be automatically braked to a standstill upon the approach to a standing obstacle.

The control functions in the two operating modes ACC and Stop & Roll are known as such, and are therefore not described here in more detail.

Speed control 10 has a decision unit 24 which, in dependence upon the respective traffic situation, decides in which operating mode the speed control is working. The criteria for these decisions will be explained in more detail below.

If decision unit 24 has selected the ACC mode, this is indicated to the driver by the lighting up of an indicator light 28 on the dashboard. Correspondingly, an indicator light 30 indicates the operating mode Stop & Roll. In addition, a loudspeaker 32 is provided, by the use of which the driver is made aware of a change in the operating mode by an acoustical signal.

In FIG. 2 the speed ranges are shown, in which the operating modes ACC and Stop & Roll (S&R) are able to be activated. Basically, the ACC mode is able to be activated when the actual speed V of the vehicle is greater than a limiting speed Vₛ. The S&R mode is able to be activated when the actual speed of the vehicle is lower than a speed Vₛ+h. The speed range between Vs and Vₛ+h is consequently a hysteresis range, in which either the ACC mode or the S&R mode may be active. As an example, let us assume that the limiting speed Vs is 30 km/h and that the hysteresis interval h is 5 km/h.

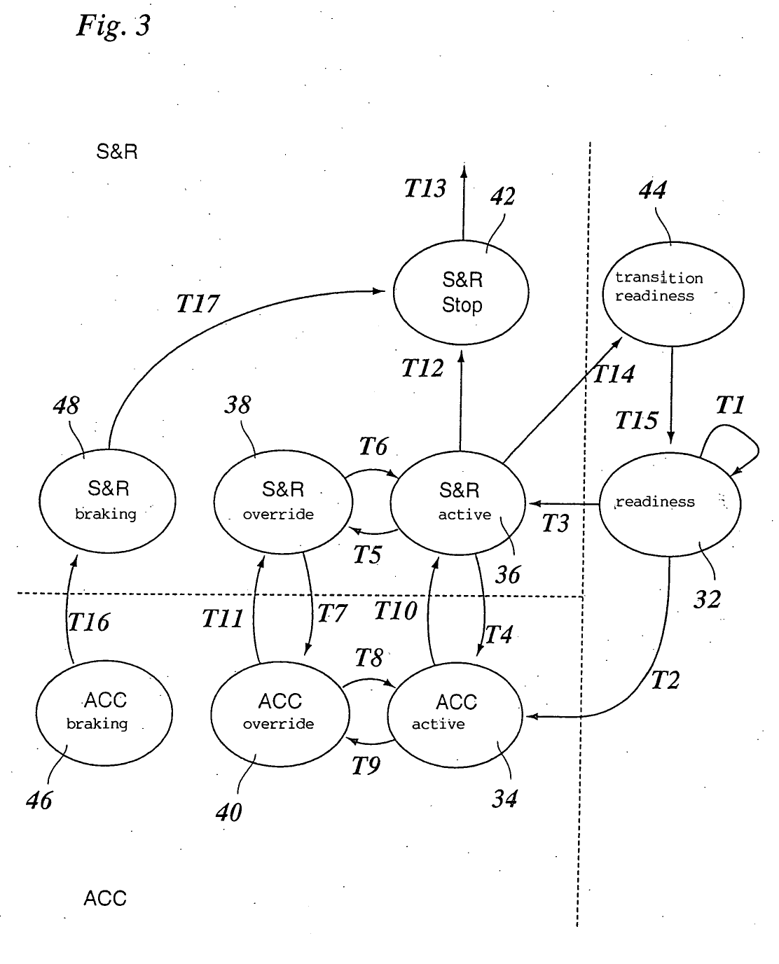

FIG. 3 shows the various operating states of the speed control as well as the most important transitions between them. The active operating states divide up into the main operating modes ACC and S&R.

In a state 32 “readiness”, the sensor systems and the evaluation and control algorithms of speed control 10 are active, so that the traffic events can be followed, but no control commands are given to the driving or the braking system of the vehicle, so that the control over the vehicle remains with the driver. So long as the driver does not actively input a command to activate the speed control, the speed control remains in the readiness state, as is symbolized by an arrow T1.

The speed control of the vehicle may be activated from V=0 by the driver's operating “+” key 12, “−” key 14 or resume key 18. Decision unit 24 then decides, in the light of the actual speed V at this moment, whether the speed control is changing into state 34 “ACC active” or into state 36 “S&R active”. If actual speed V is greater than limiting speed Vs, then upon the activation of each of the three keys 12, 14, 18, transition into state 34 “ACC active”, corresponding to arrow T2 in FIG. 3, takes place. If, on the other hand, actual speed V is less than or equal to Vₛ, transition into state 36 “S&R active” takes place according to arrow T3. As a result, the ACC mode is able to be activated only when the speed of the vehicle is at least 30 km/h. Otherwise the control goes over into the S&R mode.

In state 36 now the driver has two possibilities of accelerating the vehicle to above 30 km/h and of going over into ACC mode. On the one hand, the driver is able to select a greater desired speed, by single or multiple operation of “+” key 12, and thereby to accelerate the vehicle. As soon as the actual speed V is greater than Vₛ+h in the example assumed, that is, at least 35 km/h, decision unit 24 brings about a transition into state 34, according to arrow T4. As an alternative to that, the driver may operate the gas pedal in state 36, and thus override the S&R control function, so that, according to arrow T5, the control goes over into state 38, “override S&R”. If the vehicle is accelerated to more than Vₛ+h, there takes place, according to arrow T7, a transition into state 40 “override ACC”. If the driver now lets up the gas pedal, according to arrow T8, transition takes place into state 34 “ACC active”. In general, the driver will then select a new desired speed Vₛₑₜ which is greater than Vs.

The driver, of course, is able to override state 34 “ACC active” by operating the gas pedal, so that he temporarily reaches state 40, according to arrow T9.

Arrow T10 in FIG. 3 describes the regular transition from ACC mode into S&R mode, or, more accurately, the transition from state 34 into state 36. This transition takes place as soon as the actual speed V is less than Vₛ.

In exceptional cases, a transition from state 40 “override ACC” into state 38 “override S&R” is also possible, as indicated by arrow T11. This transition takes place when the actual speed V decreases to below Vₛ in spite of the operation of the gas pedal, e.g., when the driver has decreased the desired speed to a value below Vs, but then, by operating the gas pedal, assures that the vehicle decelerates more slowly than is specified by the speed control.

From state 36 “S&R active” a transition into a state 42 “S&R stop” is also possible, as symbolized by arrow T12. In state 42, speed control 10 effects the automatic braking of the vehicle to a standstill. Subsequently, the speed control, according to arrow T13, goes over into one of several start-up states (not shown) which determine whether the renewed starting up of the vehicle is controlled by speed control 10, if traffic conditions permit it, or when the driver confirms a corresponding start-up request, or whether the start-up procedure is controlled by the driver himself. Details of these start-up procedures are described in DE 199 58 520 A1.

The transition into state 42 according to arrow T12 takes place when, in state 36, the speed of the vehicle (the determining factor here is not the indicated but the actually measured speed) has decreased to below a threshold value such as 2 to 4 km/h, e.g. when approaching a standing obstacle.

In each of the active states, speed control 10 can be deactivated if one of several predefined events occurs. The most important of these events may be the operation of OFF key 16 by the driver and the operation of the brake pedal by the driver. In FIG. 3, deactivation from state 36 “S&R active” is shown by only an arrow T14. The speed control then runs through a transition state 44, in which the control commands given out to the drive and/or brake system are gradually driven back, so that a jerk-free transition and a correspondingly great riding comfort is achieved. From transition state 44, the speed control then goes into state 32 “readiness” again, according to arrow T15. The desired speed prevailing before the deactivation remains stored, however, and is called up again when the driver operates resume key 18 in state 32.

For the sake of completeness, in FIG. 3, still two further states 46 “ACC braking” and 48 “S&R braking” are shown, in which the speed control can only act upon the braking system of the vehicle, but not upon the drive system. These states are reached when the parking brake is operated in the ACC mode (state 34) or in the S&R mode (state 36), or when, in these modes, the electronic stability program (ESP) of the vehicle detects a lane condition having low frictional connection (e.g. an icy road). A transition is in that case only possible in the direction from the ACC mode into the S&R mode, that is, from state 46 into state 48, according to arrow T16, when the actual speed V is less than Vs. From state 48 then, according to arrow T17, braking to a standstill is possible again.

Whereas in the exemplary embodiment described here it was assumed that the desired speed is only able to be changed in intervals of 10 km/h, the present invention is applicable analogously also in the case of speed controls in which the desired speed may be changed steplessly or in smaller increments, such as at intervals of 1 km/h.

The conditions for the change between modes ACC and S&R are summarized once more in the following Table.

TABLE

| | |
|---|---|
| activation ACC | |
| T2 | V > Vₛ AND (+, − OR resume is activated) |
| activation S&R | |
| T3 | V ≦ Vₛ AND (+, − OR resume is activated) |
| S&R after ACC | |
| T4, T7 | V > Vₛ + h |
| ACC after S&R | |
| T10, T11 | V ≦ Vₛ |

1-7. (cancelled).

8. A speed control for a motor vehicle comprising:
an input device for input of a desired speed by a driver;
a plurality of operating modes which are able to be activated in different speed ranges and differ in functional scope; and
a decision unit configured to automatically undertake a switchover of the operating mode as a function of an actual speed of the vehicle.

9. The speed control as recited in claim 8, further comprising:
a display device to display the operating mode.

10. The speed control as recited in claim 8, further comprising:
a signal device configured to signal to the driver a change in the operating mode.

11. The speed control as recited in claim 8,
wherein one of the operating modes is an operating mode for higher vehicle speeds that is able to be activated only above a limiting speed, and another of the operating modes is an operating mode for lower vehicle speeds which has a function for the automatic braking of the vehicle to a standstill and is able to be activated in a speed range whose upper limit is at least equal to the limiting speed.

12. The speed control as recited in claim 11, further comprising:
a decision unit configured to automatically cause a change from the mode for higher speeds into the mode for lower speeds when the actual speed of the vehicle is less than the limiting speed.

13. The speed control as recited in claim 11, wherein the decision unit causes a change from the mode for lower speeds into the mode for higher speeds when the actual speed is greater by h than the limiting speed, where h is a nonnegative value.

14. The speed control as recited in claim 11, wherein the decision unit activates the mode for greater speeds if, in response to the input of the desired speed the actual speed of the vehicle is greater than the limiting speed and the decision unit activates the mode for lower speeds if, in response to the input of the desired speed the actual speed of the vehicle is less than or equal to the limiting speed.
